(19) United States
(12) Patent Application Publication
(10) Pub. No.: US 2008/0291031 A1
(43) Pub. Date: Nov. 27, 2008

(54) WIRELESS WARNING SYSTEM AND METHOD OF USING THE SAME

(75) Inventors: CHIN-YUAN CHEN, Jen Te (TW); CHIH-WEI CHANG, Jen Te (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tainan County (TW)

(21) Appl. No.: 11/926,663

(22) Filed: Oct. 29, 2007

(30) Foreign Application Priority Data
May 25, 2007 (TW) 96118722

(51) Int. Cl. G08B 23/00

(52) U.S. Cl. 340/573.4

(57) ABSTRACT

A wireless warning system (100) includes a primary terminal (10) and a secondary terminal (20). The primary terminal includes a first alarm apparatus (11) and a first communicating apparatus (12). The secondary terminal includes a second alarm apparatus (21) and a second communicating apparatus (22). The first communicating apparatus and the second communicating apparatus contact with each other and respectively calculate a distance between the primary terminal and the secondary terminal. The first alarm apparatus and the second alarm apparatus alarm when the calculated distance being beyond a predetermined safe distance.

### BACKGROUND OF THE INVENTION

1. Field of the Invention

The present invention relates to wireless warning systems, and particularly, to a short distance wireless warning system to prevent children from getting lost with their parents and a method of using the same.

2. Description of Related Art

When families engage in outdoor activities, it is possible for children to get lost from their parents, especially in a crowded environment. Parents are responsible to keep an eye on their children at all times. Adults usually have the abilities to contact with others via portable electronic devices, such as mobile phones or interphones. Children, on the other hand, do not have the abilities to function such conventional devices. If a child is lost from his/her parents, he/she generally is not able to send any signal to his/her parents.

Therefore, a new wireless warning system and a new wireless warning method are desired in order to overcome the above-described shortcomings.

### SUMMARY

In one aspect, a wireless warning system includes a primary terminal and a secondary terminal. The primary terminal includes a first alarm apparatus and a first communicating apparatus. The secondary terminal includes a second alarm apparatus and a second communicating apparatus. The first communicating apparatus and the second communicating apparatus communicated with each other thereby cooperatively calculating a distance between the primary terminal and the secondary terminal. The alarm apparatus will alarm when the distance detected is beyond a predetermined safe distance.

In another aspect, a wireless warning method, comprising these steps: providing a primary terminal carried by a first user and a secondary terminal carried by a second user, the primary terminal comprising a first alarm apparatus and a first communicating apparatus, the secondary terminal comprising a second alarm apparatus and a second communicating apparatus; setting a predetermined safe distance recorded in the primary terminal and recording the safe distance in the secondary terminal; activating the first communicating apparatus and the second communicating apparatus to communicate with each other thereby calculating a distance between the first user and the second user; and activating the first alarm apparatus and the second alarm apparatus to alarm when the distance calculated between the first user and the second user is beyond the safe distance.

Other advantages and novel features will become more apparent from the following detailed description when taken in conjunction with the accompanying drawings.

### BRIEF DESCRIPTION OF THE DRAWINGS

Many aspects of the present wireless warning system can be better understood with reference to the following drawings. The components in the various drawings are not necessarily drawn to scale, the emphasis instead being placed upon clearly illustrating the principles of the present wireless warning system. Moreover, in the drawings, like reference numerals designate corresponding parts throughout the figures.

FIG. 1 is a diagram of a wireless warning system in accordance with a present embodiment;

FIG. 2 is a flow chart of a wireless warning method in accordance with the present embodiment;

FIG. 3 is a flow chart of the steps of using the primary terminal of the wireless warning system shown in FIG. 1; and

FIG. 4 is a flow chart of the steps of using the secondary terminal of the wireless warning system shown in FIG. 1.

### DETAILED DESCRIPTION OF THE INVENTION

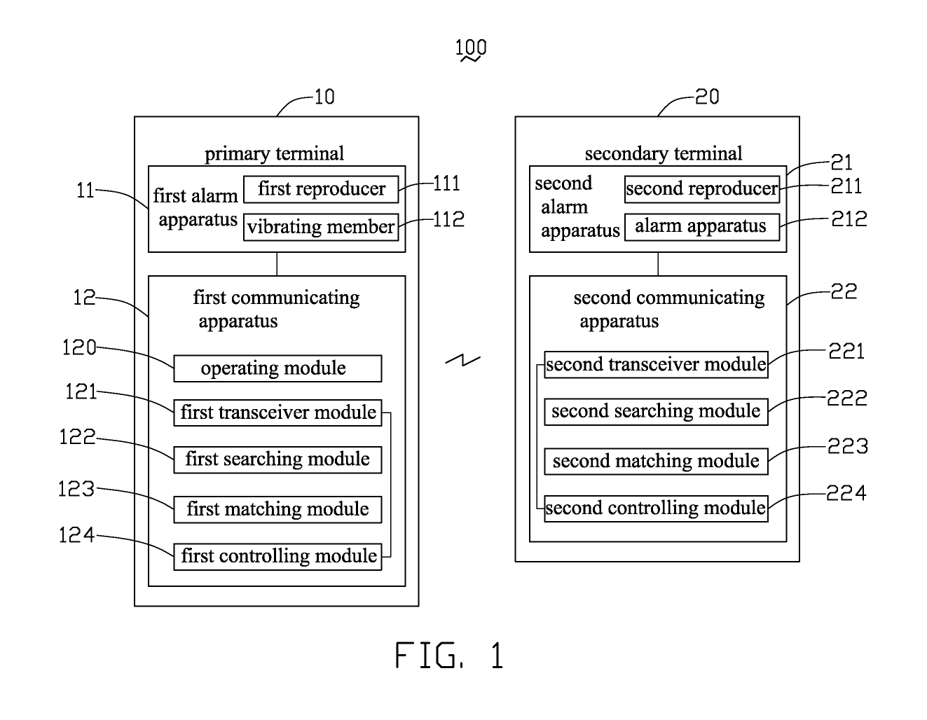

Referring to FIG. 1, a wireless warning system 100 in accordance with a present embodiment is provided. The wireless warning system 100 includes a primary terminal 10 and a secondary terminal 20. The primary terminal 10 and the secondary terminal 20 communicate with each other via wireless signals. The primary terminal 10 sends controlling signals to the secondary terminal 20, while the secondary terminal 20 feedbacks with response signals to the primary terminal 10.

The primary terminal 10 is a portable electronic device having a function of wireless communication, such as a mobile phone or a personal digital assistant (PDA). The primary terminal 10 includes a first alarm apparatus 11 and a first communicating apparatus 12 electronically connected to the first alarm apparatus 11. The first alarm apparatus 11 includes a first reproducer 111 and a vibrating member 112.

The first communicating apparatus 12 is a short distance wireless communicating module, such as a bluetooth module. The first communicating apparatus 12 includes an operating module 120, a first transceiver module 121, a first searching module 122, a first matching module 123 and a first controlling module 124. The operating module 120 is primarily used to control the first communicating apparatus 12, and particularly used to set predetermined parameters, such as a signal sending period or a safe distance between the primary terminal 10 and the secondary terminal 20. The operating module 120 can be mounted on the primary terminal 10 independently or be incorporated with typical operating components, such as keypads of the primary terminal 10. The first transceiver module 121 sends various wireless signals to the secondary terminal 20 and receives various wireless signals from the secondary terminal 20 for communicating with the secondary terminal 20. The first searching module 122 searches the secondary terminal 20 through a wireless network. The first matching module 123 is used to establish an interactive wireless communication between the primary terminal 10 and the secondary terminal 20. The first controlling module 124 is electronically connected to the first transceiver module 121. The first controlling module 124 is used to calculate a distance between the primary terminal 10 and the secondary terminal 20, and drive the first reproducer 111 to ring and the vibrating module to vibrate when the distance is beyond a predetermined safe distance.

The secondary terminal 20 includes a second alarm apparatus 21 and a second communicating apparatus 22 electronically connected to the second alarm apparatus 21. The second alarm apparatus 21 includes a second reproducer 211 and an alarm apparatus 212. The alarm apparatus 212 is a lamp.

The second communicating apparatus 22 is a short distance wireless communicating module, such as a bluetooth module similar to the first communicating apparatus 12. The second communicating apparatus 22 includes a second transceiver module 221, a second searching module 222, a second matching module 223 and a second controlling module 224. The second transceiver module 221 receives various wireless signals sent by the first transceiver module 121 of the primary terminal 10 and sends various wireless signals to the primary terminal 10 to communicate with the primary terminal 10. The second searching module 222 searches the primary terminal 10 through a wireless network. The second matching module 223 cooperates with the first matching module 123 to match the primary terminal 10 with the secondary terminal 20, thus establishing an interactive wireless communication between the primary terminal 10 and the secondary terminal 20. The second controlling module 224 is electronically connected to the second transceiver module 221. The second controlling module 224 is used to calculate a distance between the primary terminal 10 and the secondary terminal 20, and drive the second reproducer 211 to ring and the alarm apparatus 212 to shine when the distance is beyond a predetermined safe distance.

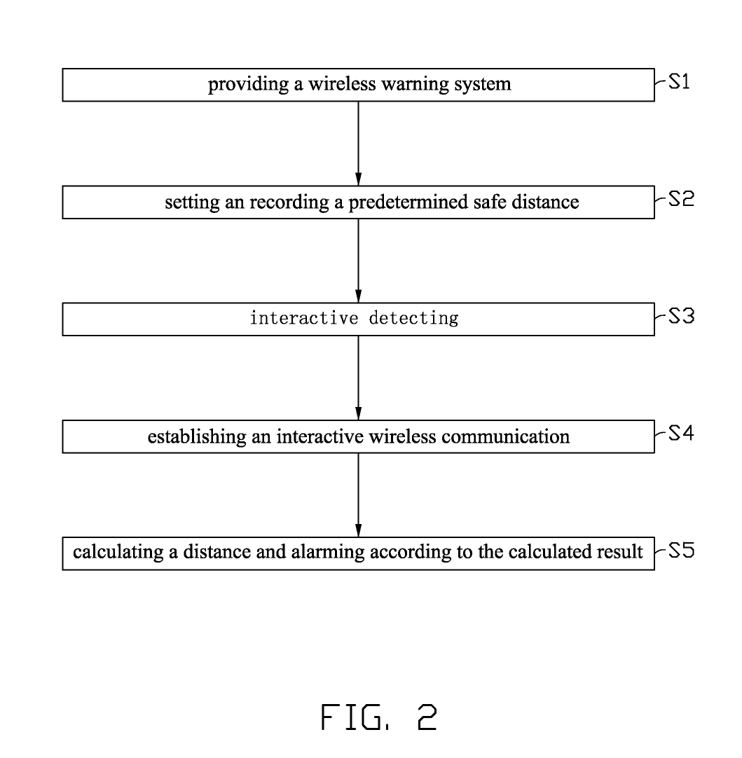

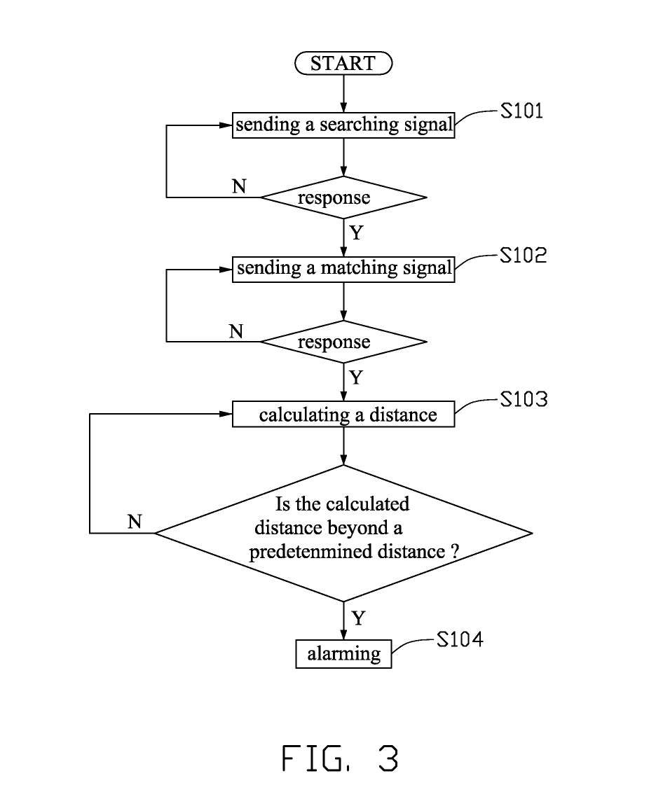

Referring to FIG. 2 and FIG. 3, a wireless warning method for locating a missing child in accordance with a present embodiment is provided. The wireless warning method includes these steps as follows.

A wireless warning system 100 is provided and carried by two users (Step S1). The primary terminal 10 of the wireless warning system 100 is turned on and carried by an adult such as one of the parents, and the secondary terminal 20 of the wireless warning system 100 is turned on and being attached to the clothes of a child.

Necessary parameters, such as a predetermined safe distance between the primary terminal 10 and the secondary terminal 20, or a period of the primary terminal 10 and the secondary terminal 20 contacting with each other, are set and recorded in the primary terminal 10 via the operating module 120 (Step S2).

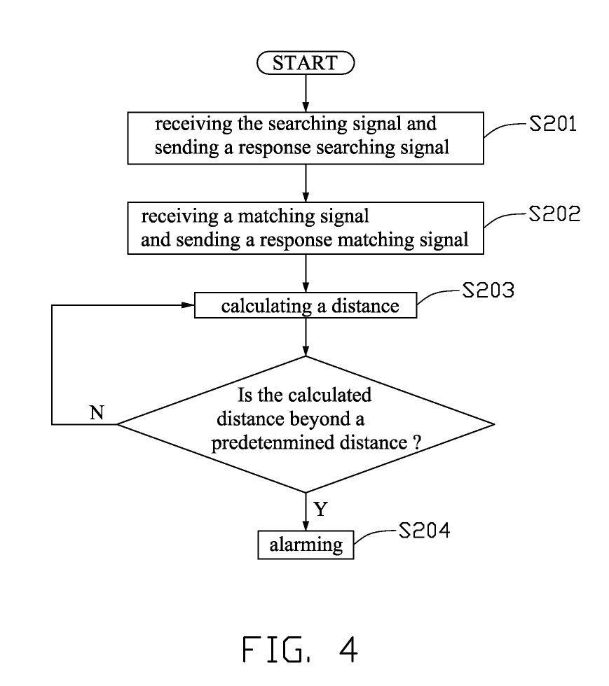

Also referring FIG. 4, the primary terminal 10 and the secondary terminal 20 interactively detect each other (Step S3). The first searching module 122 automatically sends a searching signal to detect the secondary terminal 20 (Step S101). When the second transceiver module 221 of the secondary terminal 20 receives the searching signal, and sends a response searching signal to the primary terminal 10 (Step S201). When the first transceiver module 121 receives the response searching signal, an interactive detecting between the primary terminal 10 and the secondary terminal 20 is completed. If the first transceiver module 121 cannot receive the response searching signal, the first searching module 122 successively sends searching signals until the first transceiver module 121 receives the response searching signal.

The primary terminal 10 and the secondary terminal 20 match with each other to establish an interactive wireless communication (Step S4). The first matching module 123 of the primary terminal 10 sends a matching signal to the second matching module 223 of the secondary terminal 20 (Step S102). The second transceiver module 221 receives the matching signal and transmits the matching signal to the second matching module 223, and the second matching module 223 sends a response matching signal to the primary terminal 10 (Step S202). When the first matching module 121 receives the response matching signal, the primary terminal 10 and the secondary terminal 20 matches with each other to establish a special wireless contact in a serial port profile (SPP). If the first transceiver module 121 cannot receive the response matching signal, the first matching module 123 successively sends matching signals until the first transceiver module 121 receives the response matching signal.

After matching, the parameters set and recorded in the primary terminal 10 is being sent automatically to the secondary terminal 20 and recorded by the secondary terminal 20 (Step S5). The primary terminal 10 and the secondary terminal 20 continue communicating with each other by means of receiving bluetooth wireless signals respectively sent by the second transceiver module 221 and the first transceiver module 121. In this way, the primary terminal 10 and the secondary terminal 20 calculate a distance between each other and alarms when the calculated distance is beyond a predetermined safe distance (Step S6). The first controlling module 124 periodically sends host controller interface read RSSI (Received Signal Strength Index) commands to the first transceiver module 121. The estimated time for sending RSSI commands is usually set to be approximately 4-6 seconds. When the first transceiver module 121 receives the commands, it provides an instantaneous RSSI numerical value of the bluetooth wireless signals sent by the secondary terminal 20 to the first controlling module 124. The first controlling module 124 thus calculates a distance between the primary terminal 10 and the secondary terminal 20 according to the RSSI numerical value of the bluetooth wireless signals (Step S103). If the distance between the primary terminal 10 and the secondary terminal 20 is beyond the predetermined safe distance, for example, 10 meters, the first controlling module 121 automatically drives the first reproducer 111 to ring and drives the vibrating member 112 to viberate, this way, parents with the terminal mobile 10 can quickly locate their missing child that are lost from them (Step S104). Generally, when the RSSI numerical value of the bluetooth wireless signals sent by the secondary terminal 20 is less than −65 dBm, the distance between the primary terminal 10 and the secondary terminal 20 is beyond 10 meters.

On the other hand, similar to the first controlling module 124, the second controlling module 224 periodically sends host controller interface read RSSI commands to the second transceiver module 221. The estimated time for sending RSSI commands is usually set to be approximately 4-6 seconds. When the second transceiver module 221 receives the commands, it provides an instantaneous RSSI numerical value of the bluetooth wireless signals sent by the primary terminal 10 to the second controlling module 224. The second controlling module 224 thus calculates a distance between the primary terminal 10 and the secondary terminal 20 according to the RSSI numerical value of the bluetooth wireless signals (Step S203). If the distance between the primary terminal 10 and the secondary terminal 20 is beyond the predetermined safe distance, the second controlling module 221 automatically drives the second reproducer 211 to ring and drives the alarm apparatus 212 shine. In this way, the secondary terminal 20 attached on the child can alert the surrounding people to help the child (Step S204).

Understandably, the secondary terminal 20 can be configured in shape of toys and ornaments, and the primary terminal 10 is usually a common device like mobile phone or PDA. Thus, the wireless warning system 100 could easily be attached on parents and children. Furthermore, the wireless warning system 100 is simple to use since it is unnecessary for the children to learn how to use the secondary terminal 20.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A wireless warning system, comprising:
a primary terminal which comprise a first alarm apparatus and a first communicating apparatus connected to the first alarm apparatus; and
a secondary terminal which comprise a second alarm apparatus and a second communicating apparatus connected to the second alarm apparatus; the first communicating apparatus and the second communicating apparatus communicating with each other thereby cooperatively calculating a distance between the primary terminal and the secondary terminal, the first alarm apparatus and the second alarm apparatus alarming when the calculated distance is beyond a predetermined safe distance.

2. The wireless warning system as claimed in claim 1, wherein the first communicating apparatus includes an operating module used to set the predetermined safe distance.

3. The wireless warning system as claimed in claim 1, wherein the first communicating apparatus includes a first transceiver module, a first searching module and a first matching module; the first transceiver module sends wireless signals to the secondary terminal and receives wireless signals from the secondary terminal, the first searching module searches the secondary terminal in a wireless network, the first matching module matches the primary terminal with the secondary terminal for establishing an interactive wireless communication.

4. The wireless warning system as claimed in claim 3, wherein the first communicating apparatus includes a first controlling module electronically connected to the first transceiver module.

5. The wireless warning system as claimed in claim 4, wherein the first controlling module periodically receives an instantaneous RSSI numerical value of the wireless signals sent by the secondary terminal from the first transceiver module, thus calculates a distance between the primary terminal and the secondary terminal according to the RSSI numerical value of the wireless signals.

6. The wireless warning system as claimed in claim 3, wherein the first alarm apparatus includes a first reproducer and a vibrating member.

7. The wireless warning system as claimed in claim 1, wherein the second communicating apparatus includes a second transceiver module, a second searching module and a second matching module; the second transceiver module sends wireless signals to the primary terminal and receives wireless signals sent from the primary terminal, the second searching module searches the primary terminal in a wireless network, the second matching module matches the secondary terminal with the primary terminal for establishing an interactive wireless communication.

8. The wireless warning system as claimed in claim 7, wherein the second alarm apparatus includes a second reproducer and an alarm apparatus, which is a lamp.

9. The wireless warning system as claimed in claim 8, wherein the second controlling module periodically receives an instantaneous RSSI numerical value of the wireless signals sent by the primary terminal from the second transceiver module, thus calculates a distance between the primary terminal and the secondary terminal according to the RSSI numerical value of the wireless signals.

10. The wireless warning system as claimed in claim 7, wherein the second alarm apparatus includes a second reproducer, which is electronically connected to the second communicating apparatus.

11. A wireless warning method, comprising the steps of:
providing a primary terminal carried by a first user and a secondary terminal carried by a second user, the primary terminal comprising a first alarm apparatus and a first communicating apparatus, the secondary terminal comprising a second alarm apparatus and a second communicating apparatus;
setting a predetermined distance recorded in the primary terminal and recording the predetermined distance in the secondary terminal;
activating the first communicating apparatus and the second communicating apparatus to communicate with each other thereby calculating a distance between the first user and the second user; and
activating the first alarm apparatus and the second alarm apparatus to alarm when the distance calculated between the first user and the second user is beyond the predetermined distance.

12. The wireless warning method as claimed in claim 11, further comprising a step of interactive detecting between the primary terminal and the secondary terminal after the step of providing a primary terminal carried by a first user and a secondary terminal carried by a second user.

13. The wireless warning method as claimed in claim 12, further comprising a step of matching the primary terminal and the secondary terminal for establishing a special wireless contact after the step of interactive detecting between the primary terminal and the secondary terminal.

14. The wireless warning method as claimed in claim 1, wherein the step of activating the first communicating apparatus and the second communicating apparatus to communicate with each other thereby calculating a distance between the first user and the second user includes a substep of respectively receiving an instantaneous RSSI numerical value of the wireless signals sent by each other, thus respectively calculating the distance between the primary terminal and the secondary terminal according to the RSSI numerical value of the wireless signals.

15. The wireless warning method as claimed in claim 14, wherein the period of the primary terminal and the secondary terminal receiving an instantaneous RSSI numerical value of the wireless signals sent by each other is approximately 4-6 seconds.

16. The wireless warning method as claimed in claim 11, wherein the first alarm apparatus and the second alarm apparatus are activated to alarm when the distance between the primary terminal and the secondary terminal is calculated to be beyond the predetermined distance.
